(19) United States
(12) Patent Application Publication
(10) Pub. No.: US 2006/0033653 A1
(43) Pub. Date: Feb. 16, 2006

(54) MINI REMOTE CONTROLLER

(76) Inventors: Cheng-Liang Huang, Taipei City (TW); Chung-Ho Chen, Taipei City (TW); Hsien-Wen Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/907,446

(22) Filed: Apr. 1, 2005

(30) Foreign Application Priority Data
Aug. 16, 2004 (TW) 93124513
Aug. 16, 2004 (TW) 93124512

(51) Int. Cl. G08C 19/12

(52) U.S. Cl. 341/176

(57) ABSTRACT

A mini remote control is provided. The mini remote control comprises a casing, a signal transmission unit, a control unit and a power supply. The size of the casing matches the specification of a small memory card and is suitable for inserting into a memory card slot. The user can use the mini remote control to see movies, browse pictures or play music. After viewing or playing, the user can simply insert the remote control into the memory card slot of a portable electronic device to prevent the remote control from getting lost or being misplaced somewhere else.

### CROSS-REFERENCE TO RELATED APPLICATION

This application claims the priority benefit of Taiwan applications serial no. 93124513, filed Aug. 16, 2004, and serial no. 93124512, filed Aug. 16, 2004.

### BACKGROUND OF THE INVENTION

1. Field of the Invention

The present invention relates to a remote control. More particularly, the present invention relates to a mini remote control having a specification compatible to the memory card of a portable electronic device.

2. Description of the Related Art

With the coming high-tech information age, large quantities of data are both transmitted and received every day. To facilitate interpersonal communication, the size of personal computers (PCs) has shrunk to increase portability and small portable electronic devices such as notebook computers and personal digital assistants (PDAs) have replaced PCs and become popular. To be portable, a PDA must be slim, light, small, and compact so it can be operated at anyplace and anytime. Similarly, because a notebook computer has powerful functions and is easy to carry and operate, it is a very attractive device for people on the move, office workers and students. Manufacturers, noticing the popularity of these portable devices, have also developed a large variety of peripheral products to enhance the applications of the notebook computers.

For visual-audio entertainment, a notebook computer often includes a variety of multi-media entertainment, a digital information transmission center and a place for storing important data. A student, for example, may use a notebook computer to browse photos or play music or movies. The most useful device when watching a movie is a remote control because the remote control enables the user to change functions at a distance away from the notebook computer. With the remote control at hand, there is no need to press the keys on the computer for triggering any multi-media playing function. However, the conventional remote control is a separate device entirely detached from the notebook computer. Moreover, because of the large size of a remote control, it can only be kept in a box separately from the notebook computer. If the user forgets to bring the box, it will be very inconvenient for the user to make a presentation or briefing without a remote control. The conventional remote control is not designed for housing with the notebook computer, thus it gets lost easily and is inconvenient for storage.

### SUMMARY OF THE INVENTION

Accordingly, at least one objective of the present invention is to provide a mini remote control having a specification that meets the specification of at least one type of memory card slots. Accordingly, the mini remote control can insert into the memory card slot to minimize the risk of losing the remote control and resolve the problem of storage as well.

To achieve these and other advantages and in accordance with the purpose of the invention, as embodied and broadly described herein, the invention provides a mini remote control. The mini remote control mainly comprises a casing, a signal transmission unit, a control unit and a power supply. The casing has a partial dimensional compatible to specification of at least one of the following small memory cards: a flash memory card, a mini hard disk and a pluggable storage media. The signal transmission unit is located on the casing for transmitting a wireless signal. The control unit includes a plurality of buttons disposed on the casing for executing instructions. The power supply is disposed inside the casing for providing a source of power.

According to the mini remote control in one preferred embodiment of the present invention, the power supply further includes a charging connector and a rechargeable battery. The rechargeable battery is disposed inside the casing and the rechargeable battery is charged through the charging connector.

According to the mini remote control in one preferred embodiment of the present invention, the mini remote control may further include a light source and a switching device. The light source and the switching device are disposed on the casing such that the light source can be turned on through the switching device to project a light beam. The light source is a laser beam, for example.

According to one preferred embodiment of the present invention, the casing can be fabricated using a material such as plastic or metal. Furthermore, the signal transmission unit can be an infrared transmission unit or a blue tooth transmission unit. In addition, the mini remote control can operate application programs comprised in a portable electronic device such as browsing pictures, starting a slide show or playing movie or music etc.

To achieve the aforementioned objective, the present invention also provides a portable digital device having a mini remote control. The portable digital device comprises a portable digital device casing having a first memory card slot, a second memory card slot and a signal-receiving unit. The first and the second memory card slots are compatible to at least one of the following memory cards: a flash memory card, a mini hard disk or a pluggable storage media. The mini remote control is disposed inside the first memory card slot or the second memory card slot. The mini remote control further comprises a casing, a signal transmission unit, a control unit and a power supply. The casing of the mini remote control has a partial dimensional compatible to the specification of at least one of the aforementioned small memory cards. The signal transmission unit is disposed inside the casing for transmitting a wireless signal to the signal-receiving unit. The control unit has a plurality of buttons exposed on the casing and connected to the signal transmission unit for executing an instruction to operate at least one of the application programs in the portable digital device. The power supply is disposed inside the mini remote control casing for providing a source of power.

The present invention also provides a remote control suitable for making presentations in a portable computer. The casing of the portable computer has a signal-receiving unit and at least an expansion slot. The remote control for making presentations mainly comprises a casing, a signal transmission unit, an indicator, a plurality of input keys and a power source. The remote control casing has a partial of dimension that matches the specification of the expansion slot and hence suitable for inserting the casing into the expansion slot. The signal transmission unit is disposed inside the remote control casing for transmitting a wireless signal to the signal-receiving unit. The indicator is connected to the signal transmission unit and exposed outside the remote control casing for indicating the position of a cursor. The input keys are connected to the signal transmission unit and exposed outside the remote control casing for controlling the playing of the representation data. The power supply is disposed inside the remote control casing for providing a source of power.

Accordingly, because the mini remote control of the present invention has an external dimension that matches the specification of the memory card slot, the remote control can be hold in the memory card slot. With the aforementioned characteristics, a user can simply pull out the remote control from the slot of the portable electronic device to play a movie or music. At the end of the movie playing or music listening, the remote control can once again be attached to the memory slot of the portable electronic device. The design aims to solve the problems that a remote control gets lost easily and is inconvenient to keep. Hence, the chance of losing the remote control due to dropping it off somewhere and then forgetting its whereabouts is significantly reduced. In addition, the remote control will not affect the outward appearance of the portable electronic device or occupy any additional space of the portable electronic device.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of a mini remote control inserted into a portable electronic device (having a memory card slot) according to one preferred embodiment of the present invention.

FIG. 2 is a block diagram showing the circuit control in a mini remote control according to one preferred embodiment of the present invention.

FIG. 3 is a block diagram showing control flow of a mini remote control controlling a notebook computer according to one preferred embodiment of the present invention.

FIG. 4 is a sketch showing the outward appearance of a mini remote control according to one preferred embodiment of the present invention.

FIG. 5 is a sketch showing the outward appearance of another mini remote control according to one preferred embodiment of the present invention.

FIG. 6 is a perspective view showing a remote control for making presentations inserted into a portable computer (having an expansion slot) according to another preferred embodiment of the present invention.

FIG. 7 is a sketch showing the outward appearance of a remote control for making presentations according to the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

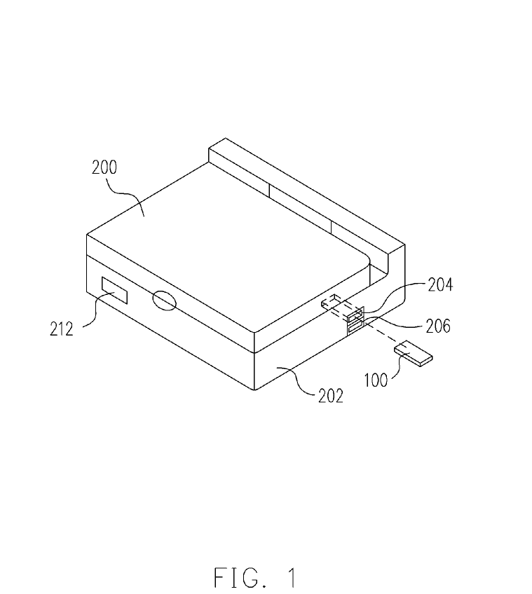

FIG. 1 is a perspective view of a mini remote control inserted into a portable electronic device (having a memory card slot) according to one preferred embodiment of the present invention. Note that the portable electronic device 200 is not limited to the notebook computer shown in FIG. 1. The portable electronic device 200 can be a digital camera, a digital video recorder or a personal digital assistant, for example. Furthermore, the portable electronic device 200 has a signal-receiving unit 212 and a plurality of memory card slots 204 and 206 compatible to at least one of the following memory cards: a flash memory card, a mini hard disk or a pluggable storage media.

In one preferred embodiment of the present invention, the portable electronic device 200 is a notebook computer (the portable electronic device 200 in FIG. 1). The bottom 202 (or the side) of the portable electronic device 200 has memory card slots 204, for example. The memory card slots 204 can accommodate at least one of the following memory cards: a CF card, an MS card, an SD card or an MMC card. The mini remote control 100 is suitable for controlling the portable electronic device 200. Moreover, the mini remote control 100 has a size compatible to a conventional memory card so that the mini remote control 100 can be inserted into any one of the memory card slots such as the CF slot of the portable electronic device 200. Hence, the mini remote control 100 can be stored within the portable electronic device 200.

Since each of the aforementioned memory cards has a different dimension and is incompatible to each other, most portable electronic devices will include a multiple of memory card slots such as the CF card slot and the MS card slot. In FIG. 1, the portable electronic device 100 has two memory card slots 204 and 206 to facilitate selection. For a user using a memory card of one particular specification such as the slot 206, the other memory card slot 204 is empty and hence can be used to store the mini remote control 100.

According to the layout shown in FIG. 1, the remote control 100 can be retrieved from the slot 204 of the portable electronic device 200 and triggered to start playing a movie if the user needs to watch a movie, for example. At the end of the show, the remote control 100 can be inserted back to the memory card slot 204 of the portable electronic device 200. Hence, the portable electronic device is able to provide a storing space for the remote control so that the chance of losing the remote control due to misplacement is reduced. Besides, the remote control does not occupy any additional space of the portable electronic device and has the same outward appearance.

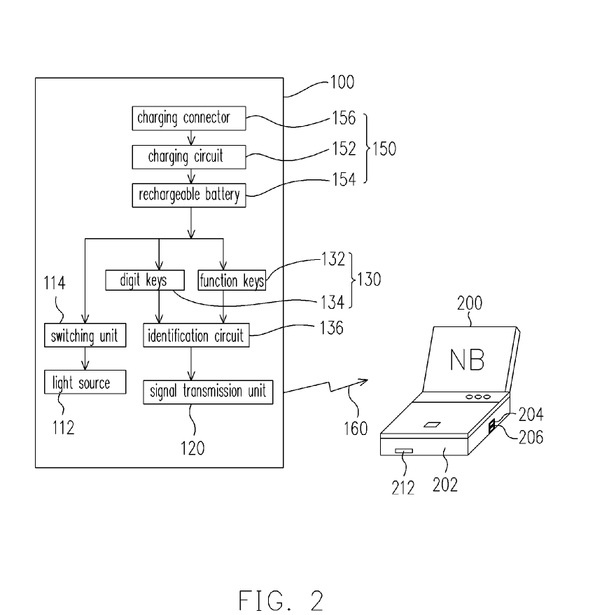

FIG. 2 is a block diagram showing the circuit control in a mini remote control according to one preferred embodiment of the present invention. The remote control 100 has a signal transmission unit 120 and a control unit 130. The control unit 130 has a plurality of digit keys 134 and a plurality of function keys 132 both electrically connected to an identification circuit 136, for example. The identification circuit 136 can identify a pressed digit key 134 or function key 132 and transmit a instruction from a key to the signal transmission unit 120. The signal transmission unit 120 then generates a signal 160 and transmits the signal 160 to a signal-receiving unit 212 of the portable electronic device 200 for controlling at least one of the application programs in the portable electronic device 200. The signal transmission unit 120 can be an infrared transmission unit or a blue tooth transmission unit for transmitting a wireless signal 160 to the signal-receiving unit 212, for example.

As shown in FIG. 2, a power supply 150 is embedded inside the mini remote control 100. The power supply 150 is disposed within a casing 110 for providing a source of power. The power supply 150 may include, for example, a rechargeable battery 154 and a charging connector 156. When the remote control 100 has used up all its internal power, the remote control 100 can be plugged into the memory card slot 204 of the portable electronic device 200. The memory card slot 204 of the portable electronic device 200 does not only provide a storage space for the remote control 100, but also provide a power source (not shown) for the mini remote control 100 via interconnecting the charging connector 156 and the memory card slot 204 and charging the rechargeable battery 154 through the charging circuit 152. However, power for driving the mini remote controller 100 is not limited to the rechargeable battery 154. Other types of battery such as a lithium (Li-ion) battery or other methods of providing power to the remote control 100 may be used.

As shown in FIG. 2, the mini remote control 100 may include a light source 112 and a switching device 114. Hence, the remote control 100 may serve as a laser pen. The laser pen may have a laser light source so that a laser beam can be projected, for example. When the switching device 114 on the remote control 100 is switched to ‘ON’, the light source 112 on the mini remote control 100 will project a beam to whatever position the user points to. In this way, the user is able to move the remote control 100 around and control the movement of the projected light beam when explaining particular content of a presentation.

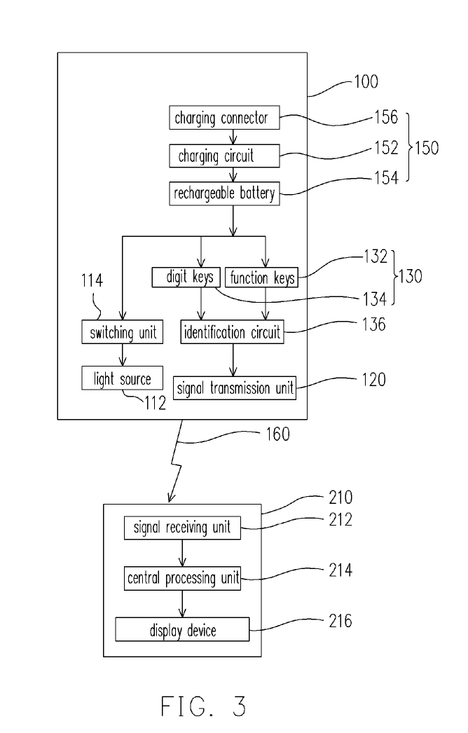

FIG. 3 is a block diagram showing control flow of a mini remote control controlling a notebook computer according to one preferred embodiment of the present invention. As a continuation of the control flow in FIG. 2, when the signal-receiving unit 212 of the portable electronic device 200 receives the signal 160, the signal 160 will be transferred to a processing unit 210 of the portable electronic device 200. The processing unit 210 includes the signal-receiving unit 212, a central processing unit (CPU) 214 and a display device 216. When one of the digital keys 134 or the function keys 132 on the mini remote control 100 is pressed, the signal transmission unit 120 within the mini remote control 100 will generate a signal 160 according to the command input by the user. After the signal 160 is received by the signal-receiving unit 212 and processed by the central processing unit (CPU) 214, the current functional state (the currently executed command, for example, “previous page”, “next page” or “stop”) will be displayed on the screen of the portable electronic device 200. Furthermore, the mini remote control 100 may operate other application programs in the portable electronic device 200 such as picture pre-viewing, slide show or movie and music playback and so on.

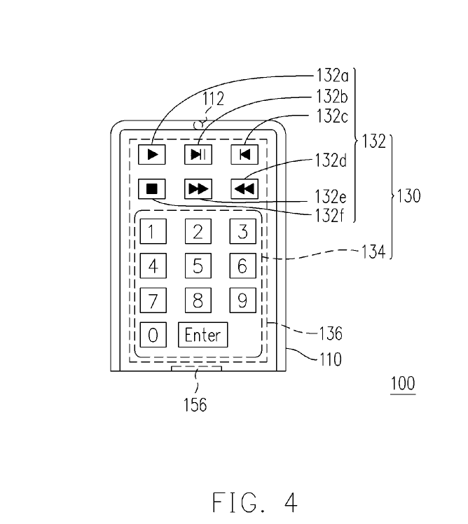

FIG. 4 is a sketch showing the outward appearance of a mini remote control according to one preferred embodiment of the present invention. As shown in FIG. 4, the mini remote control 100 mainly comprises a casing 110 fabricated to fit the dimensional specification of a memory card slot. Hence, the remote control 100 can be easily inserted into the memory card slot for easy storage. The casing 110 is fabricated using plastic or metal. Furthermore, the casing 110 may include a light source 112, a switching device 114, a signal transmission unit 120 and a control unit 130.

The control unit 130 has a plurality of digit keys 134 and a plurality of function keys 132. The function keys 132 include a play/pause key 132a, a next skip key 132b, a previous skip key 132c, a fast reverse key 132d, a fast forward key 132e and a stop key 132f. These function keys are used to control the playback of music or audio-visual software in a portable electronic device including, for example, a personal digital assistant (PDA) or a notebook computer.

The aforementioned play/pause key 132a can start or pause the playing of a current musical title or movie chapter; the next skip key 132b or the previous skip key 132c can jump to the next or the previous musical title or movie chapter; the fast reverse key 132d or the fast forward key 132e can make a fast reverse or a fast forward of the playing musical title or movie chapter; and the stop key 132f can stop the currently playing musical title or movie.

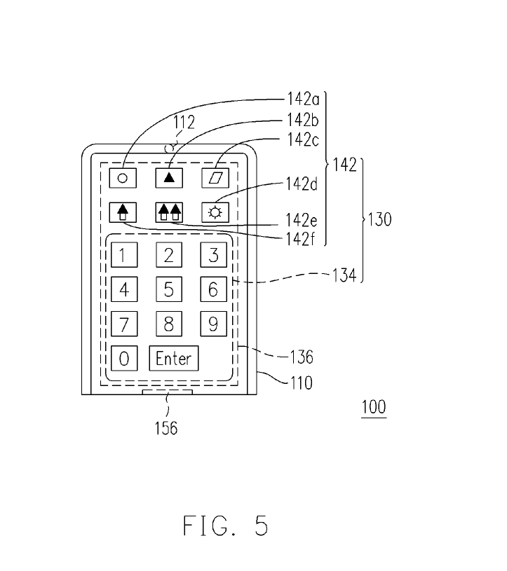

FIG. 5 is a sketch showing the outward appearance of another mini remote control according to one preferred embodiment of the present invention. As shown in FIG. 5, the mini remote control 110 not only has function keys 132 for playing musical or audio-visual software, but also has other function keys 142 for operating a digital camera or a digital camcorder. The additional functional keys include a power key 142a, a shutter key 142b, a delay key 142c, a flashlight key 142d, a zoom-in key 142e and a zoom-out key 142f.

The power key 142a can switch on or off the power to the digital camera or the digital camcorder; the shutter key 142b can trigger the digital camera or the digital camcorder to take a picture or start a recording session; the delay key 142c can provide a delay period to the digital camera or the digital camcorder before starting the picture-taking or camcorder recording operation; the flashlight key 142d can control the on or off of a flashlight when the digital camera takes pictures; the zoom-in key 142e can reduce the focus of the digital camera or the digital camcorder; and, the zoom-out key 142f can increase the focus of the digital camera or the digital camcorder.

As shown in FIGS. 4 and 5, the digit keys 134 on the mini remote control 100 including the digits 0˜9 and the Enter key (the input key) are function keys correspondingly for controlling the playback of musical software, the previewing pictures or movie in a portable electronic device such as a digital camera, a personal digital assistant (PDA) or a notebook computer. First, one of the digit keys 0˜9 is pressed to choose the number of a particular music title or movie chapter for the playback. Next, the Enter key is pressed to confirm the command. The musical playback software of the portable electronic device 200, such as a personal digital assistant, will play the input musical title. If the portable electronic device 200 is a digital camera or a digital camcorder, the picture or movie previewing software in the digital camera or the digital camcorder will display the picture or movie on a liquid crystal display screen according to the input photo or movie chapter number.

The aforementioned embodiment uses a notebook computer as an example. The external dimension of the mini remote control is fabricated according to the specification of a small memory card so that the remote control can be inserted into a memory card slot for easy storage. However, the spirit of the present invention should not be limited as such. The design concept of the mini remote control in the present invention can also be applied to other portable electronic devices such as a personal digital assistant. In addition, the present invention can also be applied to a portable electronic device that has a signal-receiving unit such as a digital video (DV) camera or a digital camera. The portable digital device comprises a plurality of different types of memory card slots, and at least one of which matches the external dimension of the remote control.

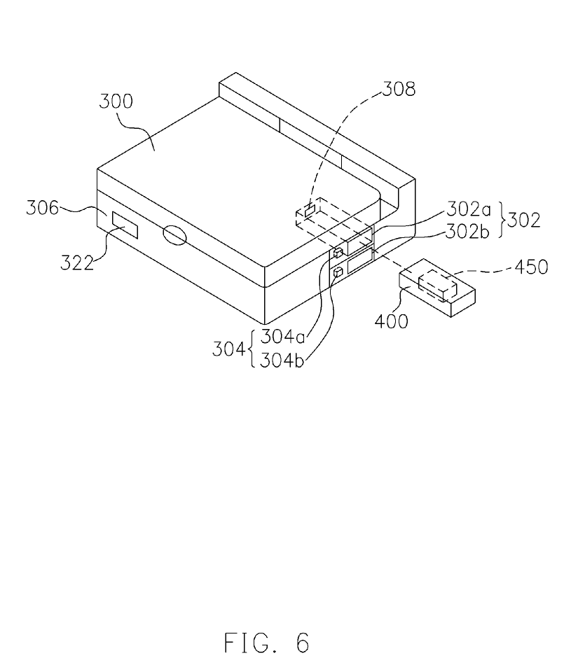

FIG. 6 is a perspective view showing a remote control for making presentations inserted into a portable computer (having an expansion slot) according to another preferred embodiment of the present invention. As shown in FIG. 6, the host 306 of the portable computer 300 has a plurality of expansion slots 302 such as the PCMCIA slots or the PCI Express slots. The remote control 400 for making presentations in the present invention has the size of a common expansion interface card and can be inserted into one of the expansion slots 302a and 302b of the notebook computer 300 for storing the remote control 400. In addition, push buttons 304a and 304b are located near the side of the expansion slots 302a and 302b. When a user needs to make a presentation, the remote control 400 can be ejected from the expansion slot 302 of the portable computer 300 by pressing the push button 304.

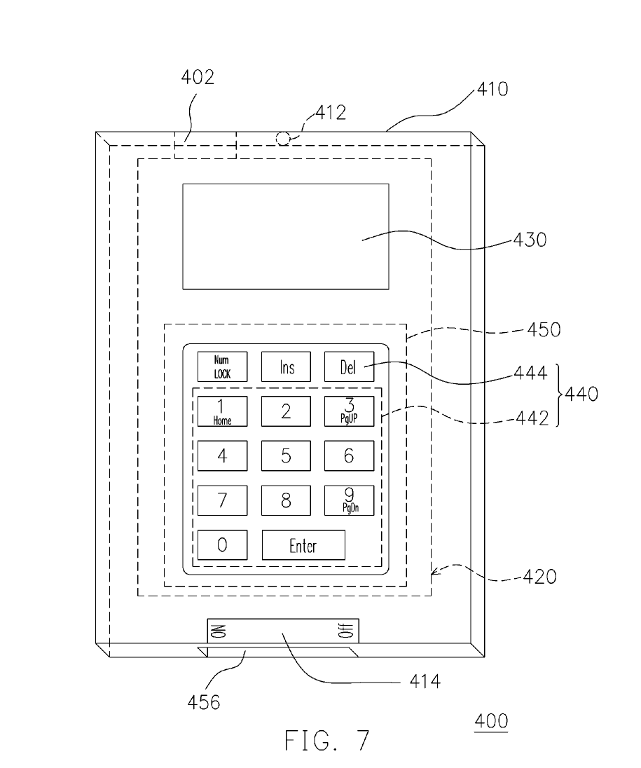

FIG. 7 is a sketch showing the outward appearance of a remote control for making presentations according to the present invention. The remote control 400 comprises a casing 410 fabricated to match the dimensional specification of the expansion slot so that the remote control can clip to the expansion slot. The casing 410 is fabricated using plastic or metal, for example. A signal transmission unit 420, an indicator 430, a plurality of input keys 440, a light source 412 and a switching device 414 are disposed inside the casing 410. The light source 412 is used as a pointer when explaining something in the presentation. When the user turns the switching device 414 of the remote control 400 to the ‘on’ position, the light source 412 on the remote control 400 will project a beam of light and hence the user can control the movement of the light by moving the remote control around. As described, the user can direct the light source 412 of the remote control 400 to anywhere when explaining particular content in the presentation. In addition, the beam of light can be a laser beam, for example. Furthermore, the input keys 440 include a plurality of digit keys 442 and a plurality of function keys 444. In the remote control 400 for making presentations, the digit keys 442 include the digits 0˜9 and the Enter key (the input key) and the function keys 444 include function exchange key (Num Lock), an insert key (Ins), a delete key (Del), a page up key (PgUp), a page down key (PgDn), a home key (Home) and an end key (End).

To operate presentation remote control 400, the page number of the presentation is first input by pressing digit keys 0˜9. Then the Enter key is pressed to confirm and initiate the action. The presentation will jump to the selected page to facilitate the user make the presentation. The function keys 444 have the function of changing pages in the presentation. For example, the Num Lock key is used for exchanging digit keys with function keys; the insert key (Ins) and the delete key (Del) can be used to insert or delete data; the page up key (PgUp) and the page down key (PgDn) can be used to move up or down one page; and the home key (Home) and the end key (End) can be used to move to the first and the last page.

The connection between the signal transmission unit 420, the indicator 430 and the power supply 450 can be referred back to FIG. 2 and its explanation. The charging connector 456 of the power supply 450 can be connected to the power supply 308 of the host 306 for charging power. The indicator 430 is used for showing the location of a cursor. The indicator 430 can be a tracker ball (not shown) or a touch control panel, for example. Using a touch control panel 430 as an example, as the fingertip moves across the touch control panel 430 of the remote control 400, the cursor in the window will move according to the movement of the fingertip. Aside from using a touch control panel 430, the remote control 400 may deploy a tracker ball (not shown) so that the cursor will move across the window according to the movement of the ball by the finger or palm.

According to the aforementioned embodiments, major advantages of the mini remote control in the present invention at least include:

1. Because the mini remote control is designed to match the dimensional specification of a memory card slot, the remote control can be conveniently stored within the memory card slot of a portable electronic device once a movie or music playback is finished. Hence, the problem of finding a storage area for holding the remote control and preventing it from getting lost due to misplacement of the remote control after use is solved.

2. Because the mini remote control can be inserted into a memory card slot, there is no need to provide any device for accommodating the remote control or introduce additional manufacturing steps. In other words, the remote control will affect neither the outward appearance of the portable electronic device nor the spatial utilization inside the portable electronic device.

3. Because the presentation remote control is designed to match the dimension specification of an expansion slot, the remote control can be inserted back to the expansion slot of the portable electronic device after the presentation. Hence, the problem of finding a storage area for holding the remote control and preventing it from getting lost due to misplacement after use is solved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mini remote control, comprising:
a casing, at least a partial dimension of which complies with a dimension specification of at least one of the following memory cards: a flash memory card, a mini hard disk or a pluggable storage media;
a signal transmission unit disposed within the casing for transmitting a wireless signal;
a control unit having a plurality of keys and disposed within the casing for executing an instruction; and
a power supply disposed within the casing for providing a source of power.

2. The mini remote control of claim 1, wherein the power supply comprises a charging connector and a chargeable battery such that the rechargeable battery is located inside the casing and can be recharged through the charging connector.

3. The mini remote control of claim 1, wherein the remote control further comprises a light source and a switching device disposed on the casing such that the light source can project a beam of light when the switching device is switched on.

4. The mini remote control of claim 3, wherein the light source is a laser.

5. The mini remote control of claim 1, wherein the material constituting the casing includes plastic or metal.

6. The mini remote control of claim 1, wherein the signal transmission unit includes an infrared transmission unit or a blue tooth transmission unit.

7. A portable digital device having a mini remote control, comprising:
a portable digital device casing having a first memory card slot, a second memory card slot and a signal-receiving unit, wherein the first and the second memory card slots are compatible to at least one of the following small memory cards: a flash memory card, a mini hard disk or a pluggable storage media; and
a mini remote control disposed inside the first memory card slot or the second memory card slot, wherein the mini remote control comprising:
a casing having at least a partial dimension complied with a dimension specification of at least one of the said memory cards;
a signal transmission unit disposed within the casing for transmitting a wireless signal to the signal-receiving unit;
a control unit having a plurality of keys connected to the signal transmission unit and exposed on the casing for executing an instruction that operates at least one of the application programs of the portable digital device; and
a power supply disposed within the casing for providing a source of power.

8. The portable digital device of claim 7, wherein the portable digital device casing includes a digital camera or a digital camcorder.

9. The portable digital device of claim 7, wherein the control unit can execute at least one of a shutter activation command, a delay activation command, a flashlight activation command and an optical/digital zooming command.

10. The portable digital device of claim 7, wherein the portable digital device casing includes a notebook computer.

11. The portable digital device of claim 7, wherein the portable digital device casing includes a personal digital assistant (PDA).

12. The portable digital device of claim 7, wherein the power supply further comprises a charging connector and a rechargeable battery disposed within the casing such that the rechargeable battery can be recharged through the charging connector.

13. The portable digital device of claim 7, wherein the mini remote control further includes a light source and a switching device disposed on the remote control casing such that the light source can project a beam of light when the switching device is switched on.

14. The portable digital device of claim 13, wherein the light source includes a laser light source.

15. The portable digital device of claim 7, wherein the application program includes an application program that provides a picture previewing function.

16. The portable digital device of claim 7, wherein the application program includes an application program that provides a slide show displaying function.

17. The portable digital device of claim 7, wherein the application program includes an application program that provides a movie playback function.

18. The portable digital device of claim 7, wherein the application program includes an application program that provides a music playback function.

19. A remote control suitable for making presentations on a portable computer, wherein the portable computer casing has a signal-receiving unit and at least an expansion slot, the remote control comprising:
a casing having at least a partial dimension complied with a dimension specification of the expansion slot and suitable for clipping to the expansion slot;
a signal transmission unit disposed within the casing for transmitting a wireless signal to the signal-receiving unit;
an indicator connected to the signal transmission unit and exposed on the casing for indicating the position of a cursor;
a plurality of input keys connected to the signal transmission unit and exposed on the casing for controlling the playback of presentation information; and
a power supply disposed within the casing for providing a source of power.

20. The remote control of claim 19, wherein the power supply comprises a charging connector and a rechargeable battery disposed within the casing such that the rechargeable battery can be recharged through the charging connector by receiving power from a power source via the expansion slot.

21. The remote control of claim 19, wherein the remote control further comprises a light source and a switching device disposed within the casing such that the light source can project a beam of light when the switching device is switched on.

22. The remote control of claim 21, wherein the light source includes a laser light source.

23. The remote control of claim 19, wherein the material constituting the casing includes plastic or metal.

24. The remote control of claim 19, wherein the signal transmission unit comprises an infrared transmission unit or a blue tooth transmission unit.

25. The remote control of claim 19, wherein the indicator includes a touch control panel.

26. The remote control of claim 19, wherein the indicator includes a tracker ball.

27. The remote control of claim 19, wherein the expansion slot is a PCMCIA expansion slot or a PCI Express slot.
